(19) United States
(12) Patent Application Publication
(10) Pub. No.: US 2007/0103623 A1
(43) Pub. Date: May 10, 2007

(54) Transflective display device

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/400,880

(22) Filed: Apr. 10, 2006

(30) Foreign Application Priority Data
Nov. 10, 2005 (CN) 200510101255.8

(51) Int. Cl. G02F 1/1335

(52) U.S. Cl. 349/114

(57) ABSTRACT

A transflective FPD device (100) having a transflective layer (120) and a color filter layer (140) is provided. The transflective layer comprises a plurality of reflective domains (224), and a plurality of transmissive domains (222), the reflective domains and the transmissive domains being alternately distributed. The reflective domains are configured for reflecting ambient light toward the color filter layer, each of the reflective domains having a plurality of reflective nano-particles associated therewith. The transmissive domains are configured allowing backlight to pass therethrough toward the color filter layer.

### BACKGROUD OF THE PRESENT INVENTION

1. Field of the Invention

The present invention relates to a transflective display device and, particularly, to a transflective flat panel display (FPD) device.

2. Discussion of the Related Art

Conventional FPD devices are generally classified into reflective devices and transmissive devices. A transmissive FPD device displays an image by using lights from a backlight source arranged on the rear side of the FPD panel, and a reflective FPD displays an image by using an ambient light.

A transmissive FPD device, which displays an image by using light from the backlight, is capable of producing a bright image with a high contrast ratio without being substantially influenced by the brightness of the environment, but consumes a lot of power due to the backlight. Moreover, a transmissive FPD device has a poor visibility under very bright environments (e.g., when used outdoor under a clear sky).

On the other hand, a reflective FPD device, which does not have a backlight, consumes little power, but the brightness and the contrast ratio thereof are substantially influenced by the conditions under which it is used, e.g., the brightness of the environment. Particularly, the visibility lowers significantly under dark environments.

In order to overcome these problems, transflective FPD devices, which are capable of operating both in a reflection mode and in a transmission mode, have been proposed in the art.

A conventional transflective FPD devices typically employs a transflective layer having a typical so-called multi-gap structure. The multi-gap structure is composed of a plurality of reflective means distributed separately, each two of which defines a transmissive gap thereby. The reflective means are configured for taking advantages of ambient lights, while the gaps are configured for allowing a backlight pass through thereby. However, since parts of the transflective layer are transmissive and the others are not, a conventional transflective FPD usually has no way to give better attention to its transmission ability and its reflection ability. Furthermore, the above-mentioned multi-gap structure is disposed above a liquid crystal layer and a color filter layer, in that an FPD device using such does not perform a satisfactory color saturation.

Therefore, what is needed in the art is to provide a transflective FPD device giving better attention to its transmission ability and its reflection ability and having a satisfactory color saturation.

### SUMMARY

According to the present display, a transflective FPD device having a transflective layer and a color filter layer is provided. The transflective layer comprises a plurality of reflective domains, and a plurality of transmissive domains, the reflective domains and the transmissive domains being alternately distributed. The reflective domains are configured for reflecting ambient light toward the color filter layer, each of the reflective domains having a plurality of reflective nano-particles associated therewith. The transmissive domains are configured allowing backlight to pass therethrough toward the color filter layer.

An advantage of the FPD device is that such a device has better reflection efficient, thus less reflection area is needed and more transmission area can be used for transmitting the backlight.

Another advantage of the FPD device is that when the FPD device displays mainly relying on ambient light, the ambient light travels twice through the color filter layer, and therefore the FPD device can perform a better color saturation.

### BRIEF DESCRIPTION OF THE DRAWINGS

The above-mentioned and other features and advantages of the present transflective flat panel display device, and the manner of attaining them, will become more apparent and the invention will be better understood by reference to the following description of its embodiments taken in conjunction with the accompanying drawings.

FIG. 1 is a schematic, cross-sectional view of an FPD device, according to an embodiment; and

FIG. 2 is a schematic, cross-sectional view of preferred structure of a combination between a transflective layer and a color filter layer formed thereon, according to an embodiment of the FPD device; and

FIG. 3 preferred structure of a transflective layer 220 and a color filter layer, according to another embodiment of the FPD device.

Corresponding reference characters indicate corresponding parts throughout the several views. The exemplifications set out herein illustrate at least one preferred embodiment of the invention, in one form, and such exemplifications are not to be construed as limiting the scope of the invention in any manner.

### DETAILED DESCRIPTION OF PREFERRED EMBODIMENTS

Reference will now be made to the drawings to describe the preferred embodiments of the present FPD device in detail.

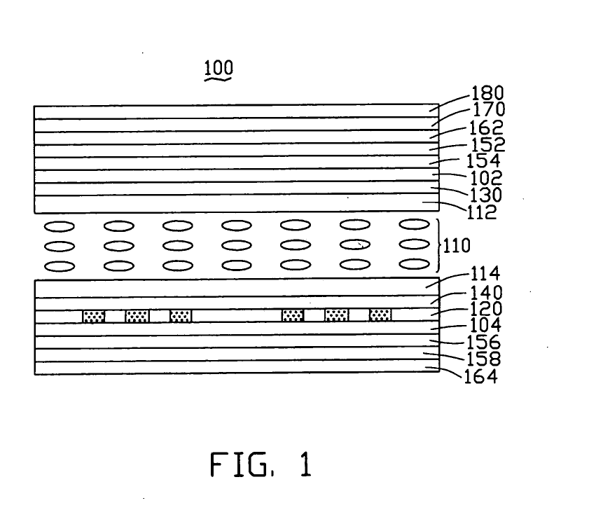

Referring now to the drawings, and more particularly to FIG. 1, there is shown a transflective FPD device 100. The transflective FPD device 100 includes an upper substrate 102, a lower substrate 104, a liquid crystal layer 110, a transflective layer 120, a thin film transistor (TFT) layer 130, a color filter layer 140, an upper polarizer 162 and a lower polarizer 164. The liquid crystal layer 110 is interposed between the upper substrate 102 and the lower substrate 104, and includes a plurality of liquid crystal molecules. The liquid crystal layer 110 further includes an upper alignment film 112 disposed thereon, and a lower alignment film 114 disposed thereunder. The upper alignment film 112 and the lower alignment film 114 are configured for aligning the liquid crystal molecules to control lights passed thereby. The transflective layer 120 and the color filter layer 140 are combined as a whole and are interposed between the liquid crystal layer 110 and the lower substrate 104. The transflective layer 120 is close to the lower substrate 104 and the color filter layer 140 is close to the liquid crystal layer 130, in that the color filter layer 140 is located on the transflective layer 120. The transflective layer 120 is configured for allowing a backlight transmit therethrough to the liquid crystal layer 110 and allowing a light of environment be reflected back to the liquid crystal layer 110. The TFT layer 130 is interposed between the upper substrate 102 and the liquid crystal layer 110, for driving the FPD device to display. The upper polarizer 162 and the lower polarizer 164 are respectively configured for providing polarized light source for displaying.

According to an aspect of the embodiment of the FPD device, the transflective FPD device 100 further includes an upper ½ wave plate 152, an upper ¼ wave plate 154, a lower ¼ wave plate 156, a lower ½ wave plate 158. The upper ½ wave plate 152 and the upper ¼ wave plate 154 are interposed between the upper substrate 102 and the upper polarizer 162, while the lower ¼ wave plate 156 and the lower ½ wave plate 158 are interposed between the lower substrate 104 and the lower polarizer 164. The positions of the upper ½ wave plate 152 and the upper ¼ wave plate 154 are exchangeable, and the positions of the lower ¼ wave plate 156 and the lower ½ wave plate 158 are also exchangeable. The wave plates 152, 154, 156 and 158 are configured for complementing a phase delay of the tranflective FPD device 100. It is to be noted that other phase complementary components can also be employed to perform such a function.

Furthermore, according to another aspect of the embodiment of the FPD device, the transflective FPD device 100 may further include an anti-glare coating layer 170 and a anti-reflection coating layer 180. The anti-glare coating layer 170 is disposed on the upper polarizer 162 for eliminating uncomfortableness caused by excessive strong ambient light light. The anti-reflection coating layer 180 is disposed on the anti-glare coating layer 170 for allowing more lights in a given wavelength band pass through.

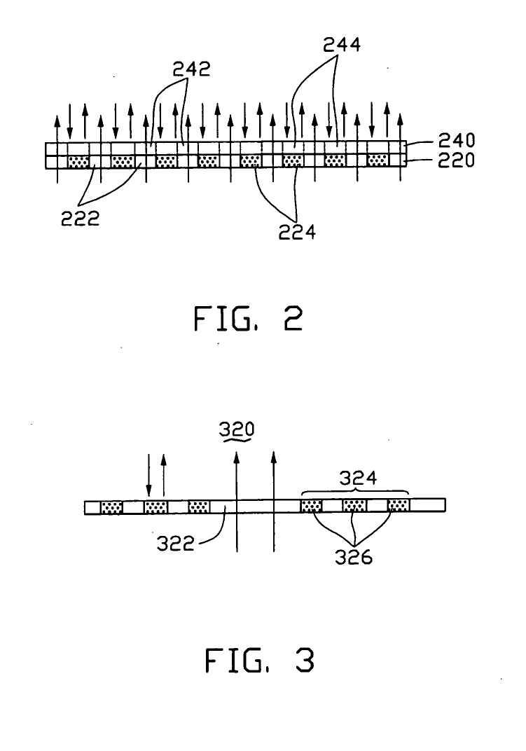

Referring now to FIG. 2, it illustrates a preferred structure of a combination between a transflective layer 220 and a color filter layer 240 formed thereon, according to an embodiment of the FPD device. The transflective layer 220 includes a plurality of reflective domains 224 for reflecting an ambient light for displaying, and a plurality of transmissive domains 222 for transmitting a backlight for displaying. The reflective domains 224 and the transmissive domains 222 are alternately distributed. Each of the reflective domains 224 further includes a plurality of reflective nano-particles distributed thereon for enhancing the reflecting ability thereof. Sizes of the nano-particles for example are in the approximate range of 2 nm to 100 nm and preferably in the approximate range of 5 nm to 20 nm.

In general, the transflective layer 220 is made of a material selected from a group consisting of Ag, Al, Ti, Cr and Al—Ag alloy. To configure such a transflective layer 220, a layer of one of the foregoing materials is deposited at first, and a plurality of nano-particles are disposed thereby or thereafter. And then, a lithographic process is performed to form a certain pattern on the deposited layer. Finally, an etching process is performed to remove unneeded parts of the deposited layer, thus configuring the transflective layer 120 having a given pattern.

Accordingly, the transflective layer 220 has a plurality of reflective domains 224 comprised of deposited reflective materials and a plurality of transmissive domains 222 defined as spaces by the reflective domanins. In this embodiment, the reflective domains are preferably formed in a pattern comprised of a plurality of parallel straight strips, which define the transmissive domains as a plurality of straight gaps parallel to each other.

Again referring to FIG. 2, the color filter layer 240 is formed on the transflective layer 220. The color filter layer 240 includes a plurality of reflective filter units 244 corresponding to the reflective domains 224 of the transflective layer 220, and a plurality of transmissive filter units 242 corresponding to the transmissive domains 222 of the transflective layer 220. The reflective filter units 244 are configured for twice filtering an ambient light to provide respectively red, green and blue lights to the liquid crystal layer 110 for displaying. The transmissive filter units 242 are configured for filtering a backlight to provide respectively red, green and blue lights to the liquid crystal layer 110 for displaying. Each of the transmissive filter units 244 has a part filled in a corresponding transmissive domain. Therefore, the transmissive filter units 244 are thicker than the reflective filter units 242, the thickness ratio between the reflective filter units 242 and the transmissive filter units 244 being in the range of 40% to 60% (preferably 45% to 55%). Furthermore, the area ratio between the reflective filter units 242 and the transmissive filter units 244 is in the range of 40% to 60% (preferably 45% to 55%).

With respect to the foregoing color filter layer 240, a thicker transmissive filter unit 242 provides better color saturation to a backlight transmitted therethrough for displaying. Similarly, a structure of a reflective filter unit 244 on a reflective domain 224 has an ambient light transmitted twice therethrough thus also providing a better color saturation to the ambient light for displaying.

Referring now to FIG. 3, it illustrates a preferred structure of a transflective layer 320 according to an embodiment of the FPD device. The transflective layer 320 includes a plurality of transmissive domains 322 and a plurality of reflective domains 324. Each of the reflective domains 324 further includes a plurality of sub-reflective domains 326. Each of the sub-reflective domains 326 further includes a plurality of reflective nano-particles distributed thereon for enhancing the reflecting ability thereof. Sizes of the nano-particles for example are in the approximate range of 2 nm to 100 nm and preferably in the approximate range of 5 nm to 20 nm. The sub-reflective domains 326 for example can be a plurality of reflective strips parallel to each other.

Moreover, the transmissive domains 322 for example can be formed by an process similar to that of FIG. 2. Thus a color filter layer like FIG. 2 shown can be mounted on the transflective layer 320. The color filter layer includes a plurality of thicker transmission filter units corresponding to the transmissive domains 322 for allowing backlights pass therethrough, and a plurality of thinner reflection filter units corresponding to the reflective domains 324 for allowing ambient lights twice reflected and pass therethrough.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A transflective FPD device comprising a transflective layer and a color filter layer configured on the transflective layer, the transflective layer comprising:
a plurality of reflective domains configured for reflecting ambient light toward the color filter layer, each of the reflective domains having a plurality of reflective nano-particles; and
a plurality of transmissive domains configured allowing backlight to pass therethrough toward the color filter layer,
wherein the reflective domains and the transmissive domains are alternately distributed.

2. The transflective FPD device as described in claim 1, wherein sizes of the nano-particles are in the approximate range of 2 nm to 100 nm.

3. The transflective FPD device as described in claim 1, wherein the transflective layer is made of a material selected from a group consisting of Ag, Al, Ti, Cr and Al—Ag alloy.

4. The transflective FPD device as described in claim 1, wherein the reflective domains are configured to be elongated and parallel to each other.

5. The transflective FPD device as described in claim 1, wherein the color filter layer comprises:
a plurality of reflective filter units spatially corresponding to the reflective domains of the transflective layer, configured for twice filtering ambient light to provide light of given colors; and
a plurality of transmissive filter units spatially corresponding to the transmissive domains of the transflective layer, configured for filtering a backlight to provide respectively red, green and blue light for display use.

6. The transflective FPD device as described in claim 5, wherein the transmissive filter units are thicker than the reflective filter units.

7. The transflective FPD device as described in claim 6, wherein the thickness ratio of the reflective filter units to the transmissive filter units is in the range of 40% to 60%

8. The transflective FPD device as described in claim 5, wherein the area ratio of the reflective filter units to the transmissive filter units is in the range of 40% to 60%.

9. The transflective FPD device as described in claim 5, wherein the color filter layer comprises a plurality of reflective filter units spatially corresponding to the reflective domains of the transflective layer, and a plurality of transmissive filter units spatially corresponding to the transmissive domains of the transflective layer.

10. A transflective FPD device comprising a transflective layer and a color filter layer configured on the transflective layer, the transflective layer comprising:
a plurality of reflective domains configured for reflecting ambient light toward the color filter layer, each of the reflective domains further comprising a plurality of sub-reflective domains; and
a plurality of transmissive domains configured allowing backlight to pass therethrough toward the color filter layer.

11. The transflective FPD device as described in claim 10, wherein the reflective domains and the transmissive domains are alternately distributed.

12. The transflective FPD device as described in claim 10, wherein the transflective layer is made of a material selected from a group consisting of Ag, Al, Ti, Cr and Al—Ag alloy.

13. The transflective FPD device as described in claim 10, wherein the reflective domains are configured to be elongated and parallel to each other.

14. The transflective FPD device as described in claim 10, wherein the area ratio of the reflective filter units to the transmissive filter units is in the range of 40% to 60%.

15. The transflective FPD device as described in claim 10, wherein the sub-reflective domains are configured to be elongated and parallel to each other.

16. The transflective FPD device as described in claim 10, wherein the color filter layer comprises:
a plurality of reflective filter units spatically corresponding to the reflective domains of the transflective layer, configured for twice filtering the ambient light to provide respectively red, green and blue light for display use; and
a plurality of transmissive filter units corresponding to the transmissive domains of the transflective layer, configured for filtering a backlight to provide respectively red, green and blue lights for display use.

17. The transflective FPD device as described in claim 16, wherein the transmissive filter units are thicker than the reflective filter units.

18. The transflective FPD device as described in claim 17, wherein the thickness ratio of the reflective filter units to the transmissive filter units is in the range of 40% to 60%.

19. The transflective FPD device as described in claim 16, wherein the area ratio of the reflective filter units to the transmissive filter units is in the range of 40% to 60%.
